(19) United States
(12) Patent Application Publication
(10) Pub. No.: US 2011/0155759 A1
(43) Pub. Date: Jun. 30, 2011

(54) Sample dispensing display system

(76) Inventor: Benjamin Weshler, New York, NY (US)

(21) Appl. No.: 12/928,847

(22) Filed: Dec. 20, 2010

Related U.S. Application Data
(60) Provisional application No. 61/284,781, filed on Dec. 24, 2009.

(51) Int. Cl. B67D 7/84; B67D 7/06

(52) U.S. Cl. 222/23; 222/113; 222/173; 222/135; 222/108; 222/52

(57) ABSTRACT

A sample dispensing display system includes a dispensing assembly having top and front portions, and defining an interior cavity, wherein the top portion of the dispensing assembly defines a product area for holding and displaying products, at least one fluid delivery mechanism being disposed within the interior cavity of the dispensing assembly, wherein the at least one fluid delivery mechanism each has a tubular shaft extending from the front portion of the dispensing assembly with an outlet disposed at the distal end of the tubular shaft, and at least one sample dispenser source for storing a flowable material corresponding to a product displayed in the product area, wherein the sample dispenser source is fluidly connected to a respective fluid delivery mechanism for supplying the flowable material.

### CROSS-REFERENCE TO RELATED APPLICATION

This application claims the benefit of U.S. Provisional Patent Application No. 61/284,781, filed Dec. 24, 2009.

### FIELD OF THE INVENTION

The present invention is directed generally to product display systems for consumer products, and more particularly to a sample dispensing display system adapted for displaying products in a secure manner, and having at least one sample dispenser for conveniently allowing consumers to test or sample a product prior to purchase.

### BACKGROUND OF THE INVENTION

Product display systems are widely used in retail settings to facilitate sales of goods or products. Such product display systems are generally designed for informing consumers about the products offered, and for providing an orderly and pleasing arrangement of the products to enhance visibility and access. For products such as cosmetics and the like, the product display systems may further include testing devices to enable the consumer to test the product prior to purchase. Typically, the products and testers are housed in a display system which is open and readily available to the consumer. Such display systems are subject to excessive handling by consumers, which invariably detracts from the display system and the products which are displayed. In addition, the products and testing devices utilized by such display systems are easily vandalized and susceptible to theft.

Quite obviously, the disadvantages associated with such conventional display systems are detrimental to both the supplier of the products and the retail establishments, which offer the products for sale. Accordingly, many retailers keep product display systems including those displaying cosmetics under lock and key. Such systems address the concerns described above but make it more difficult for the consumer to test and/or purchase the product. In particular, the consumer must have the display system unlocked by a retail employee before being able to access the product. This can take considerable time, especially during busy retail sale activity (e.g., the holidays), and often results in a deterrent to purchase.

Accordingly, there continues to be a need for a sample dispensing display system adapted for displaying products in a visually appealing manner, while protectively securing the products from damage or theft. There further continues to be a need for a sample dispensing display system adapted for permitting consumers to test or sample a product on display prior to purchase and facilitating such testing of the product in a hygienic or sanitary manner. There further continues to be a need for a sample dispensing display system capable of accommodating for display products of various sizes or dimensions utilizing a modular construction to enhance flexibility and ease of use, and improve convenience.

### SUMMARY OF THE INVENTION

The present invention relates generally to a sample dispensing display system having one or more display modules, each adapted for displaying products in an attractive and secure manner, and each having at least one sample dispenser for allowing consumers to test or sample a product prior to purchase. The sample dispensing display system of the present invention may further include an information module adapted for conveying information to the consumer (e.g., details about the product displayed). The sample dispensing display system of the present invention is further designed to permit consumers to test or sample a product on display prior to purchase, facilitate such testing of the product in a hygienic or sanitary manner and avoid problems of tampering and theft typically associated with displays utilizing unsecured testers. The sample dispensing display system is capable of accommodating for display, products of various sizes or dimensions utilizing a modular construction to enhance convenience and ease of use.

In one aspect of the present invention, there is provided a sample dispensing display system, comprising:

a dispensing assembly having top and front portions, and defining an interior cavity, the top portion of the dispensing assembly defining a product area for holding and displaying products;

at least one fluid delivery mechanism being disposed within the interior cavity of the dispensing assembly, the at least one fluid delivery mechanism each having a tubular shaft extending from the front portion of the dispensing assembly with an outlet disposed at the distal end of the tubular shaft; and

at least one sample dispenser source (e.g., bottle) for storing a flowable material corresponding to a product displayed in the product area, the sample dispenser source being fluidly connected to a respective fluid delivery mechanism for supplying the flowable material.

### BRIEF DESCRIPTION OF THE DRAWINGS

The following drawings are illustrative of embodiments of the present invention and are not intended to limit the invention as encompassed by the claims forming part of the application.

FIG. 1 is an overall perspective view of a sample dispensing display system in accordance with one embodiment of the present invention;

FIG. 2 is a perspective view of a display module of the sample dispensing display system mounted on a wall support in accordance with one embodiment of the present invention;

FIG. 3 is a partial assembly view of two display modules of the sample dispensing display system in accordance with the present invention;

FIGS. 4A and 4B are front and rear perspective views, respectively, of a carrier assembly of the sample dispensing display system in accordance with the present invention;

FIG. 5 is an exploded assembly view of the display module in accordance with the present invention;

FIG. 6 is a right side cutaway view of the display module in accordance with the present invention;

FIGS. 7A and 7B are perspective views of a sample dispenser in a closed state position and in an open position, respectively, for another embodiment of the present invention;

FIG. 8 is a perspective view of a fluid delivery mechanism for one embodiment of the present invention;

FIG. 9 is an exploded assembly view of the fluid delivery mechanism of FIG. 8 in accordance with the present invention;

FIG. 10 is a partially exploded assembly view of the fluid delivery mechanism of FIG. 8 in accordance with the present invention;

FIG. 11 is a perspective view of a fluid delivery mechanism for another embodiment of the present invention;

FIG. 12 is an exploded assembly view of the fluid delivery mechanism of FIG. 11 in accordance with the present invention;

FIG. 13 is an overall perspective view of a sample dispensing display system in accordance with another embodiment of the present invention;

FIG. 14 is a perspective view of the sample dispensing display system of FIG. 14 in accordance with the present invention; and

FIG. 15 is an exploded assembly view of a display module of the sample dispensing display system of FIG. 14 in accordance with the present invention.

### DETAILED DESCRIPTION OF THE INVENTION

The present invention is directed generally to a sample dispensing display system having one or more display modules, each adapted for displaying products in an attractive and secure manner, and each having at least one sample dispenser for allowing consumers to test or sample a product prior to purchase. The sample dispensing display system of the present invention may further include an information module adapted for conveying information to the consumer (e.g., details about the product displayed). The sample dispensing display system of the present invention is designed to permit consumers to test or sample a product on display prior to purchase, facilitate such testing of the product in a hygienic or sanitary manner and avoid problems of tampering and theft typically associated with displays utilizing unsecured testers. The sample dispensing display system is capable of accommodating for display, products of various sizes or dimensions utilizing a modular construction to enhance convenience and ease of use.

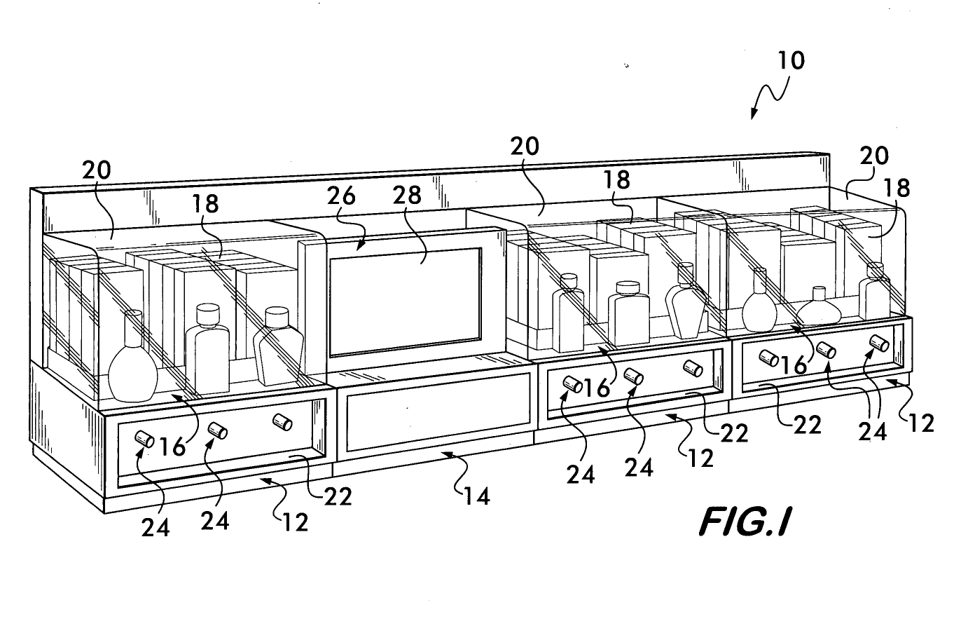

Referring to FIG. 1, a sample dispensing display system identified generally by reference numeral 10 is shown for one embodiment of the present invention. The display system 10 is designed to display and present products of various sizes and shapes in a secure and orderly manner, while providing means for permitting consumers to sample or test the product before purchasing. The products accommodated by the display system 10 include, but are not limited to, personal care products, cosmetics, perfumery and the like suitable for sale or distribution to the consumer. The display system 10 may be constructed for placement on a horizontal surface such as a countertop area, or for secure mounting to an upright structure such as a wall as will be described hereinafter.

The display system 10 includes one or more display modules 12, and an information module 14, each arranged juxtaposed with adjacent ones in a side-by-side configuration. The display module 12 and the information delivery module 14 are each adapted for relatively simple assembly and disassembly as needed. The display module 12 includes a product area 16 for accommodating placement of products 18 thereon, a display housing 20 enclosing the product area 16, and a dispensing assembly 22 having one or more sample dispensers 24. Preferably, the products 18 are arranged within the product area 16 in rows positioned adjacent to one another. The display housing 20 may further be adapted for providing selective access to the product area 16, while allowing consumers to view the products 18 contained therein. At least one portion of the display housing 20 is fabricated from a non-opaque material, and preferably a substantially transparent material, to allow the products 18 contained therein to be viewed.

The sample dispensers 24 of the display module 12 are each adapted to be actuated by the consumer for dispensing a predetermined quantity or volume of a corresponding product 18. The sample dispensers 24 are designed to dispense any flowable material, including, but not limited to, liquids, gels, foams, creams, slurries, pastes, powders, suspensions, aerosols, and the like. In this manner, the consumer is provided an opportunity to sample or test the product prior to purchase. The sample dispensers 24 are each designed with a modular construction for easy installation or replacement within the display module 12 as will be further described hereinafter. In a preferred embodiment of the present invention, the sample dispenser 24 may be actuated through a contact-free switch or control as will be described hereinafter.

The information module 14 is configured for conveying product details and other information useful for aiding or assisting with the consumer's selection of a product 18. The information module 14 includes an information conveying means 26 which may be in the form of a interactive display, a poster or placard, a chart, a booklet, a pamphlet rack, and the like. In a preferred embodiment of the present invention, the information conveying means 26 is an interactive touch-sensitive display or monitor 28 configured to dynamically communicate user-selectable information in a multimedia format. Such displays or monitors 28 can readily be designed to provide the appropriate information including its arrangement and layout by those skilled in the art.

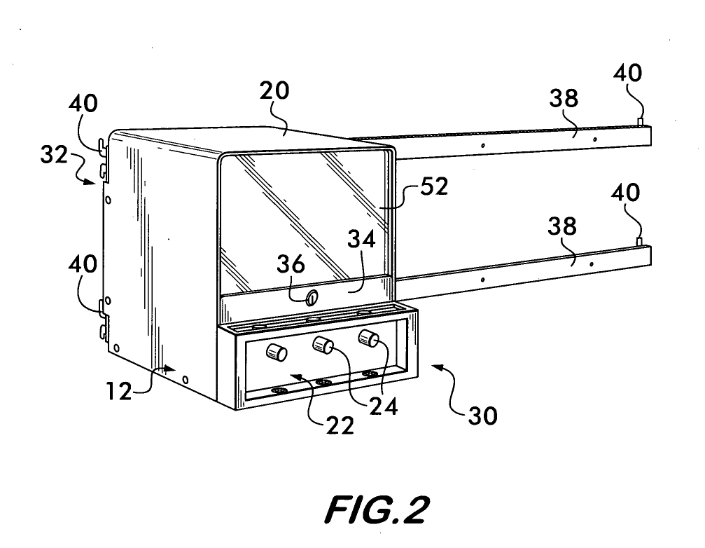

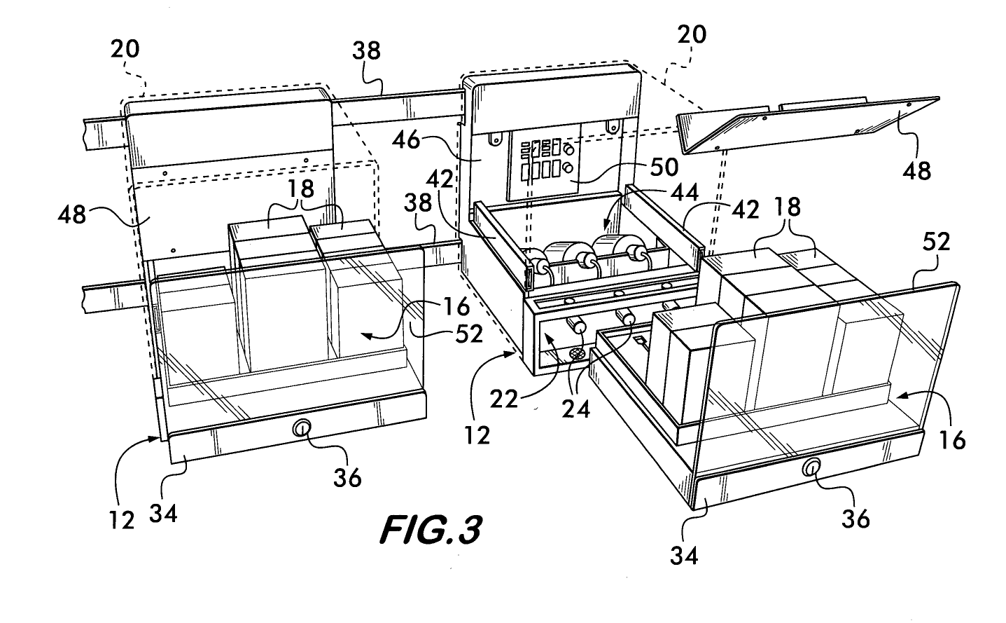

Referring to FIGS. 2 and 3, the display housing 20 of the display module 12 includes a forward side portion 30 and a rear side portion 32. The forward side portion 30 of the display housing 20 includes a carrier or drawer 34 movable from a closed position (as shown in FIG. 2) to an opened position (as shown in the left-side display module 12 of FIG. 3). The carrier 34 includes a display panel 52 forming part of the display housing 20 at the forward end thereof. The carrier 34 can be moved to the opened position to permit access to the product area 16 for purveying or re-stocking products 18. The carrier 34 may optionally include a locking mechanism 36 for selectively locking the carrier 34 in the closed position to secure the products 18 in the product area 16.

As shown in FIG. 3, the carrier 34 is slidably mounted on a pair of opposing side-mounted slides 42. The slide mechanism may encompass any conventional forms including, but not limited to, friction slides, bearing slides such as linear bearing slides, roller bearing slides, progressive action slides, and the liked. The carrier 34 is configured to be slidably movable to a fully extended position. The slides 42 may further be configured for permitting the carrier 34 to be removed to provide access to an interior area 44 of the dispensing assembly 22 as will be further described hereinafter. The display module 12 further includes a rear compartment 46 enclosed by a removable panel 48 for housing a circuit board 50. The circuit board 50 is configured to control the operation of the sample dispensers 24 as will be described hereinafter.

The rear side portion 32 of the display housing 20 is configured for securing the display module 12 onto a pair of top and bottom support bars 38, which are affixed to vertical structure such as a wall. The information module 14 is similarly constructed for mounting onto the top and bottom support bars 38. The display and information modules 12 and 14 can be positioned along the length of the support bars 38 to achieve a desired layout and appearance. The support bars 38 are affixed via mounting brackets 40 located at each end thereof (as shown best in FIG. 2) to a corresponding support structure (not shown) installed in the wall.

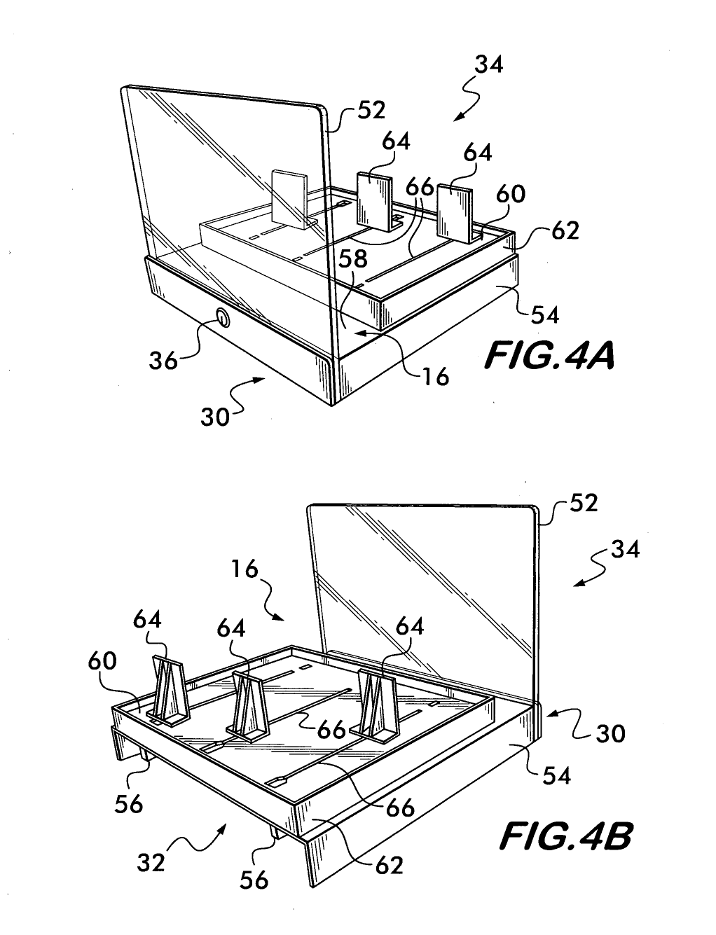

Referring to FIGS. 4A and 4B, the carrier 34 includes a base 54 defining the product area 16, and a pair of opposed slotted rails 56 located beneath the base 54 operatively engaged to the corresponding slides 42 of the housing 20 to provide the carrier 34 with a sliding motion. The product area 16 includes a first section 58 located proximate to the forward end 30 of the carrier 34, and a second section 60 located rearward from the first section 58. The first section 58 holds the unpackaged or unboxed products 18 near the display panel 52, which provides a display for the consumer. The second section 60 is adapted to hold the packaged or boxed products 18 for sale or distribution to the consumer.

The second section 60 further includes a tray-like partition 62 extending along the periphery thereof, and one or more pushers 64 adapted for retaining the products 18 in a neat and orderly layout. The second section 60 provides a well-organized space for displaying the products 18 in an orderly manner to draw the consumer's attention on the product 18, while allowing the products 18 to be re-stocked with relative ease. The pushers 64 are slidably mounted in a corresponding pusher track 66, and spring-biased to slide towards the front end 30 of the carrier 34.

The products 18 are retained in one or more rows within the second section 60 between the pusher 64 and the forward portion of the tray partition 62. The retained products 18 are constantly urged forward via the pusher 64 when the forward-most products 18 are successively removed therefrom. In this manner, the pusher 64 continuously moves the remaining products 18 forward to the position previously occupied by the removed product 18, and ensures that the products 18 are reachable for the next consumer. Alternative examples of suitable pusher mechanisms and product area configurations are shown and disclosed in U.S. Provisional Patent Application Ser. No. 61/133,967, entitled “Adjustable Display Tray Assembly”, filed on Jul. 24, 2008, and U.S. patent application Ser. No. 12/881,234, entitled “Adjustable Product Display System”, filed on Mar. 10, 2009, the entire contents and details of which are incorporated herein by reference.

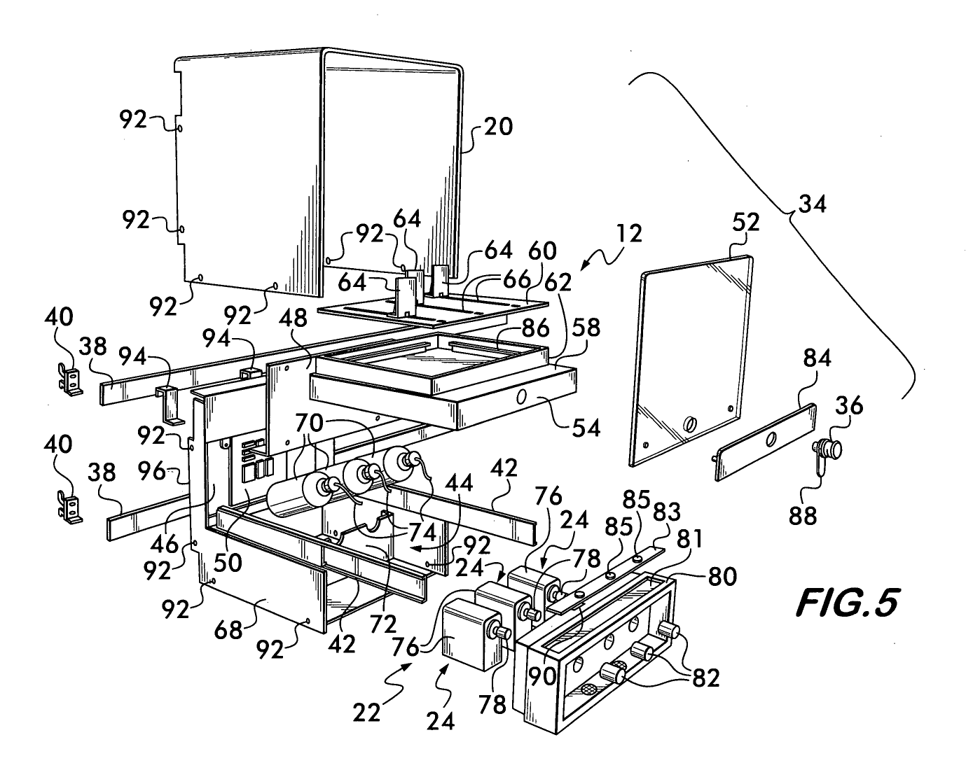

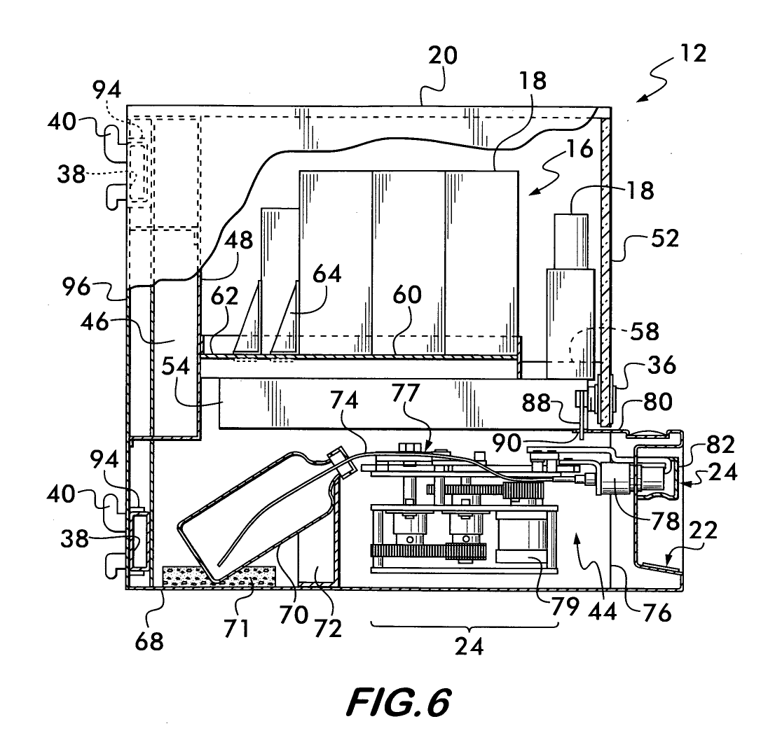

Referring to FIGS. 5 and 6, the housing 20 of the display module 12 further includes a base portion 68 housing the dispensing assembly 22 including the sample dispensers 24. The display assembly 22 further includes one or more sample dispenser sources or bottles 70 each held in place by a foam pad 71 with the upper portion of the bottles 70 supported on a vertical partition 72 rigidly attached to the base portion 68. The sample dispenser bottles 70 are each filled with samples of the corresponding products 18 displayed in the product area 16. The sample dispensers 24 are disposed proximate to the partition 72 on the side opposite from the bottles 70, and each fluidly coupled to the bottle 70 via a tubing 74 extending therebetween.

The sample dispensers 24 each include a housing 76, and a nozzle 78 projecting through a forward portion 80 of the base portion 68. Each nozzle 78 is fitted with a cap 82. The forward portion 80 attached to the forward end of the base portion 68, encloses the sample dispensers 24 within the interior area 44. The forward portion 80 further includes a recessed portion 81 for receiving and retaining a pad 83 having three push buttons 85. The push buttons 85 are each electrically connected to the circuit board 50. Each of the sample dispensers 24 is electrically connected to the circuit board 50.

During use, the consumer presses a push button 85 corresponding to a particular sample dispenser 24 of a product to generate a dispensing signal to the circuit board 50. The circuit board 50 receiving the dispensing signal generates an actuating signal to the corresponding sample dispenser 24. The actuating signal initiates a cam assembly 77 through a rotational step motor 79 (shown best in FIG. 6).

The cam assembly 77 applies a compression force to the nozzle 78, which may be, for example, a standard perfume spray head. The compressed nozzle 78 dispenses a fixed volume of the tester product drawn through the tubing 74 into the consumer's hand positioned below the cap 82. The circuit board 50 deactivates the sample dispenser 24 for a predetermined time (i.e., 10 seconds) to limit the volume of the tester product dispensed within a single cycle to prevent excessive dispensing.

It will be understood that the sample dispenser in the present invention may be manually or electronically operable depending on the requirements of the display system of the present invention. Furthermore, the circuit board 50 of the display system may be in the form a central controller unit adapted for simultaneously controlling multiple sample dispensers or multiple controller units each dedicated for controlling a corresponding sample dispenser during operation.

As discussed previously, the carrier 34 is slidably mounted on the slides 42. The slides 42 are affixed to the upper part of the base portion 68, and coupled to the slotted rails 56 of the carrier 34 to provide a sliding motion therebetween. A mounting bar plate 84 is affixed to the forward end of the carrier base 54 to retain the display panel 52 to the carrier 34. The locking mechanism 36 is inserted and mounted through the bar plate 84, the display panel 52 and the carrier base 54. The locking mechanism 36 includes a rotatable tab 88 configured to engage a slot 90 located on the top of the forward portion 80 for locking the carrier 34 in the retracted position. The second section 60 of the product area 16 is fabricated with a board-like construction having the spring-biased pushers 64 mounted in the corresponding tracks 66. The second section 60 is placed on protrusions 86 disposed along the inner periphery of the tray-like partition 62.

The housing 20 is secured to the base portion 68 via suitable fasteners (not shown) at corresponding fastening holes 92. The panel 48 is mounted to the interior rear area of the base portion 68 via suitable fasteners (not shown) to enclose the circuit board 50 within the rear compartment 46. The base portion 68 includes an exterior rear portion 95 configured to retain mounting hooks 94 for engagement with the top and bottom support bars 38, respectively. The use of the mounting hooks 94 allows the user to conveniently mount and remove the display modules 12 on the wall as needed without requiring the additional use of tools and fasteners.

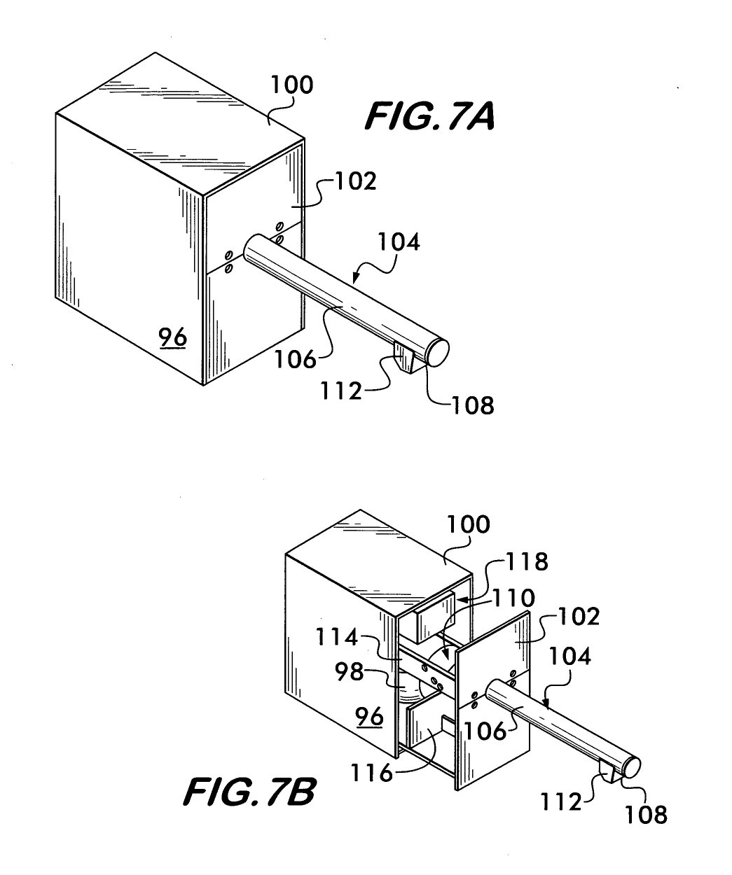

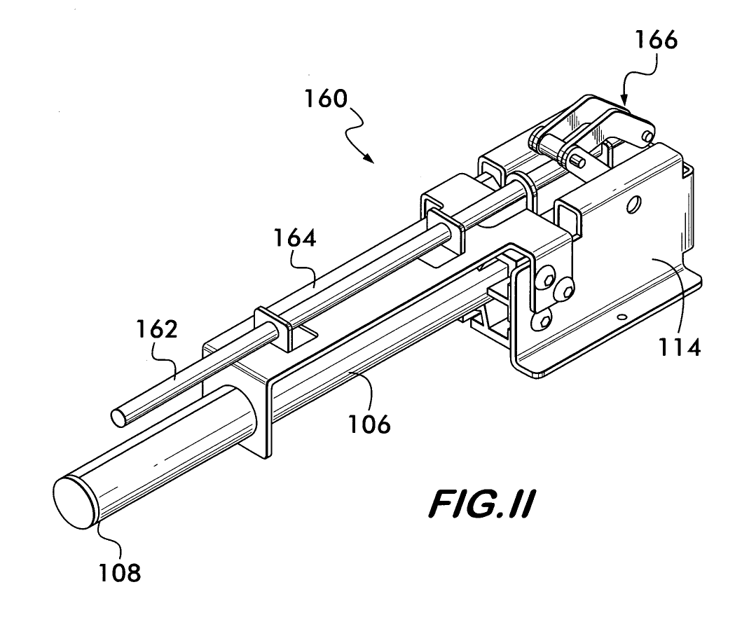

With reference to FIGS. 7A and 7B, a sample dispenser 96 having a self-contained sample dispenser bottle 98 (see FIG. 7B) is shown for another embodiment of the present invention. The sample dispenser bottle 98 is designed to hold a volume of a flowable substance or material including, but not limited to, liquids, gels, foams, creams, slurries, pastes, powders, suspensions, aerosols, and the like. The sample dispenser 96 is adapted to deliver a predetermined quantity of the flowable substance or material from the sample dispenser bottle 98. The sample dispenser 96, constructed as a modular component for the display module 12, further includes a housing 100 having an access panel 102, a fluid delivery mechanism 104 extending therefrom, and a controller unit 118 (as best shown in FIG. 10) located within the housing 100 for directing the fluid delivery mechanism 104. The fluid delivery mechanism 104 and controller unit 118 are designed to facilitate the actuation of the dispensing of the flowable substance or material without physical contact.

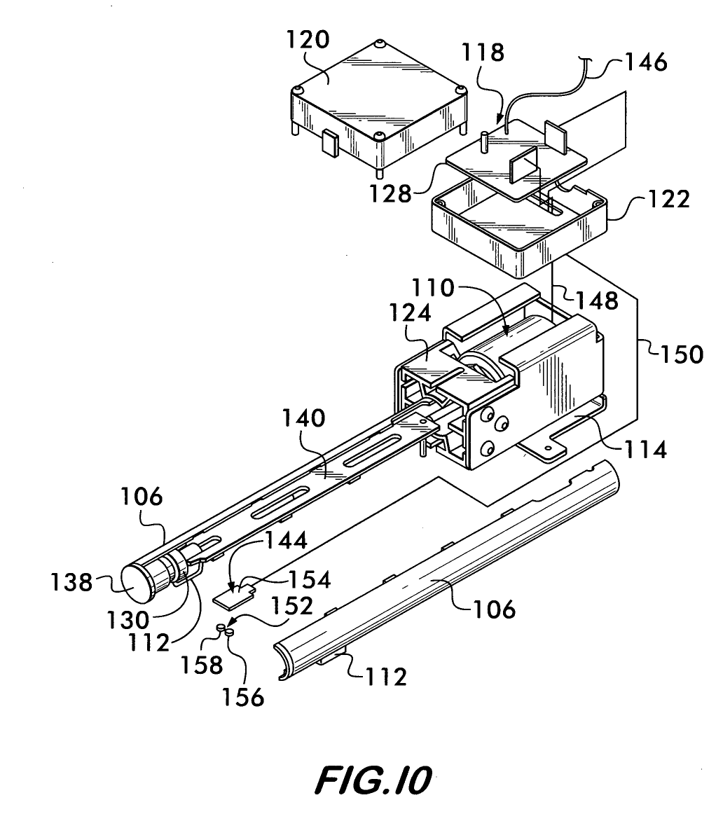

The fluid delivery mechanism 104 includes a tubular shaft 106 extending through the access panel 102 of the housing 100. The tubular shaft 106 includes an outlet 108 and a remote sensor assembly 144 (as shown best in FIG. 10) retained by a light transmissible sensor cover 112 located at the distal end thereof, and a solenoid assembly 110 enclosed within the housing 100. The solenoid assembly 110 actuates a stock nozzle assembly 130 (see FIGS. 9 and 10) located within the distal end of the tubular shaft 106 proximate the outlet 108. The stock nozzle assembly 130 is adapted to draw fluid from the sample dispenser bottle 98 for dispensing through the outlet 108 as will be described hereinafter. The access panel 102 permits access into the housing 100 to the solenoid assembly 110 and the sample dispenser bottle 98 supported on an upstanding wall 116 (as shown best in FIG. 7B). A fluid conveying tubing (not shown) provides a fluid connection between the sample dispenser bottle 98 and the fluid delivery mechanism 104. The fluid delivery mechanism 104 is securely mounted to the access panel 102 through a bracket 114.

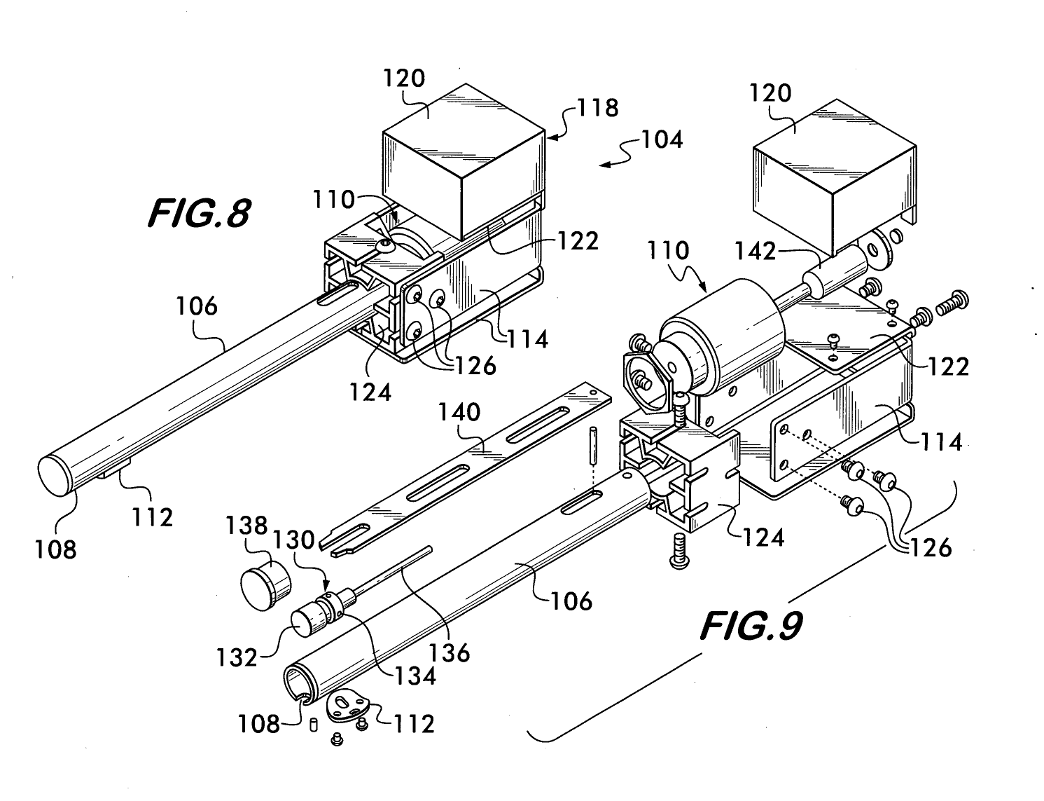

Referring to FIG. 8, the fluid delivery mechanism 104 is controlled by the controller unit 118 electrically connected to the solenoid assembly 110. A suitable example of the solenoid assembly 110 is the DC Cylindrical Solenoid Model No. S-07174 available from Magnet-Shultz of America, Inc. of Westmont, Ill. The controller unit 118 includes a housing 120 and base plate 122 for holding a circuit board 128 (as shown in FIG. 10) to the bracket 114. The circuit board 128 is programmed to regulate the operation of the fluid delivery mechanism 104 as will be described hereinafter. The base 122 of the controller unit 118 is rigidly attached to the top portion of the bracket 114. The tubular shaft 106 and the solenoid assembly 110 are attached to the bracket 114 via a molded solenoid mount 124. The molded solenoid mount 124 is secured to the bracket 114 by fasteners 126. It is noted that the particulars of the circuit board 128 may be readily discerned by one of ordinary skill in the art based on the simple operating requirements discussed hereinafter.

Referring to FIG. 9, the fluid delivery mechanism 104 further includes nozzle assembly 130 having a nozzle head 132 with an aperture (not shown), a nozzle body 134 and a dip tube 136, disposed within the distal end of the tubular shaft 106. The nozzle head 132 is oriented so that the nozzle aperture (not shown) is aligned with the outlet 108 of the tubular shaft 106. The nozzle head 132 and the outlet 108 of the tubular shaft 106 are fixed in a set position so that dispensing of the flowable material from the nozzle aperture (not shown) is conducted only in a fixed direction toward the consumer's hand. The tubular shaft 106 is rigidly fixed in position to the molded solenoid mount 124 and the bracket 114, thus preventing the tubular shaft 106, the nozzle head 132 and the outlet 108 from rotating out of position, and ensuring proper direction of dispensing.

The fluid delivery mechanism 104 also includes an end cap 138 enclosing the nozzle assembly 130 within the tubular shaft 106 and an inner plate 140 located within the tubular shaft 106. The end cap 138 securely retains the nozzle head 132 in the proper position within the tubular shaft 106, and in fluid communication with the outlet 108. The dip tube 136 of the nozzle assembly 130 is connected to a corresponding sample dispenser bottle 98 via a fluid tubing (not shown). The inner plate 140 is positioned in engagement between the nozzle assembly 130 and a solenoid shaft 142 of the solenoid assembly 110 (as shown best in FIG. 10). Upon activation of the solenoid assembly 110, the solenoid shaft 142 is urged against the inner plate 140, which causes the nozzle assembly 130 to dispense a predetermined quantity of a fluid through the downwardly oriented outlet 108.

Referring to FIG. 10, the controller unit 118 includes the circuit board 128 connected to a power source (not shown) via a power line 146, the solenoid assembly 110 via a solenoid line 148, and the remote sensor assembly 144 via a sensor line 150. The remote sensor assembly 144 includes sensor components 152 electrically connected to a sensor circuit board 154, which are housed in the light transmissible sensor cover 112. The remote sensor assembly 144 is configured to sense or detect the presence of an object positioned at a predetermined location below the outlet 108.

The sensor components 152 comprise an optical transmitter 156 and an optical receiver 158 each located adjacent to one another. The optical transmitter 156 emits an electromagnetic radiation in the form of light such as infrared light downwardly below the outlet 108. When an object (e.g., consumer's hand) is positioned in the path of the light generated by the optical transmitter 156, a portion of the light is reflected back to the remote sensor assembly 144. The optical receiver 158 is configured to detect this reflected portion of the light emitted by the optical transmitter 156.

The sensor circuit board 154 measures the intensity of the reflected electromagnetic radiation via the optical receiver 158 and converts it into a sensor signal sent to the controller unit 118 via the sensor line 150. When the sensor signal reaches a particular threshold level such as when the consumer's hand is present for a predetermined time period (e.g., 2 seconds), the controller unit 118 generates a dispensing signal only as a single pulse to initiate a single dispensing event. The dispensing signal is sent to the solenoid assembly 110 via the solenoid line 148.

The solenoid assembly 110, responsive to the dispensing signal, is activated which delivers a force transferred through the inner plate 140 to the nozzle assembly 130. This causes the nozzle body 134 to draw the fluid from the sample dispenser bottle 98 through the fluid tubing (not shown) in the tubular shaft 106 and dispense the drawn fluid out through the outlet 108. The outlet 108 directs the fluid downwardly onto the consumer's hand to facilitate testing or sampling of the fluid.

Once the fluid is dispensed, the controller unit 118 remains inactive until the withdrawal of the consumer's hand, and after an additional short time delay (e.g., 10 seconds). The predetermined time delay prevents excessive dispensing of the fluid within a single cycle. The controller unit 118 may be further programmed to prime the fluid delivery mechanism 104. A microswitch (not shown) may be provided to initiate a series of multiple solenoid activations to compress the stock nozzle assembly 130 to draw the fluid from the sample dispenser bottle 98.

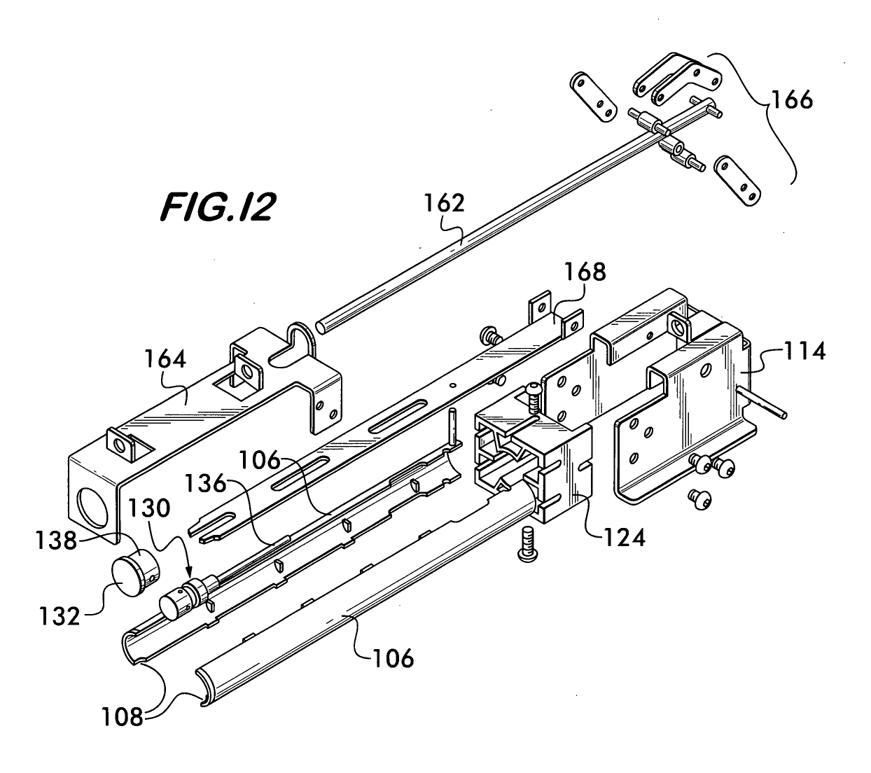

Referring to FIGS. 11 and 12, a fluid delivery mechanism 160 is shown for another embodiment of the present invention. The fluid delivery mechanism 160 is similar in structure to the fluid delivery mechanism 104 except for the absence of the controller unit, solenoid assembly and the remote sensor assembly of the previous embodiment. Instead, the fluid delivery mechanism 160 includes a push button rod 162 mounted on a push button guide 164, and a linkage assembly 166 connecting the push button rod 162 to an inner plate 168 (see FIG. 12) to actuate the nozzle assembly 130. The push button rod 162 extends through the dispensing assembly 22 of the display module 12, and can be manually depressed by the consumer. This moves the push button rod 162 rearward towards the bracket 114. The linkage assembly 166 translates the rearward movement of the push button rod 162 to urge the inner plate 168 forward against the standard nozzle assembly 30. This initiates the dispensing of a predetermined quantity of the fluid from a corresponding sample dispenser bottle 98 through the downwardly directed outlet 108.

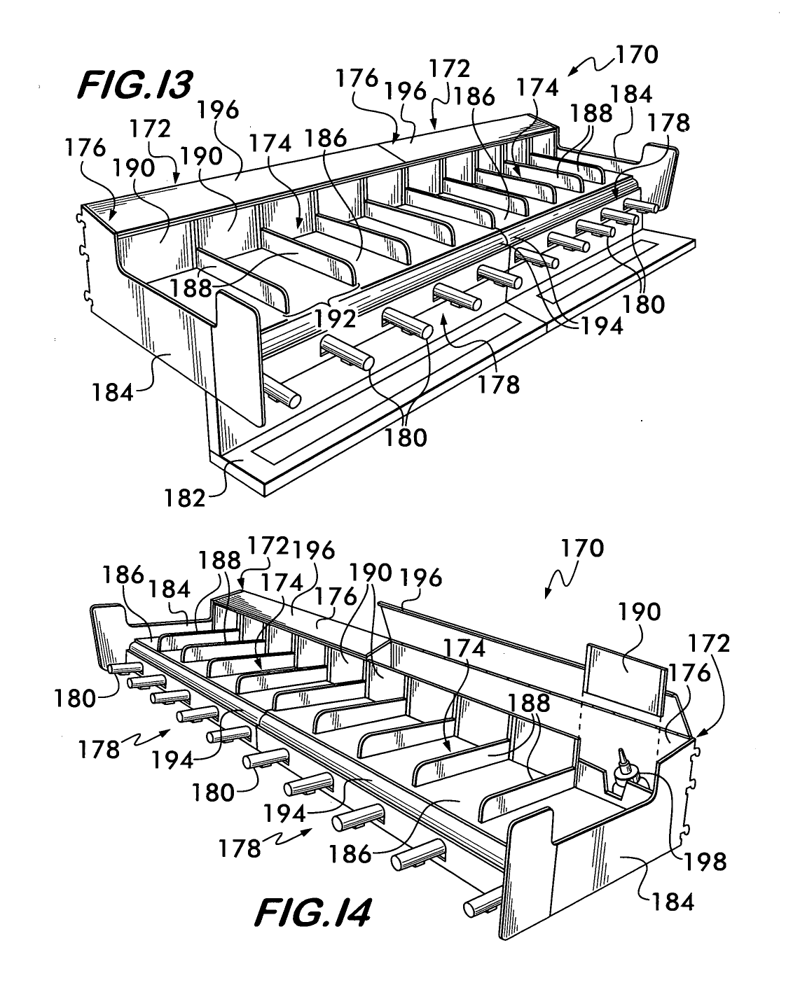

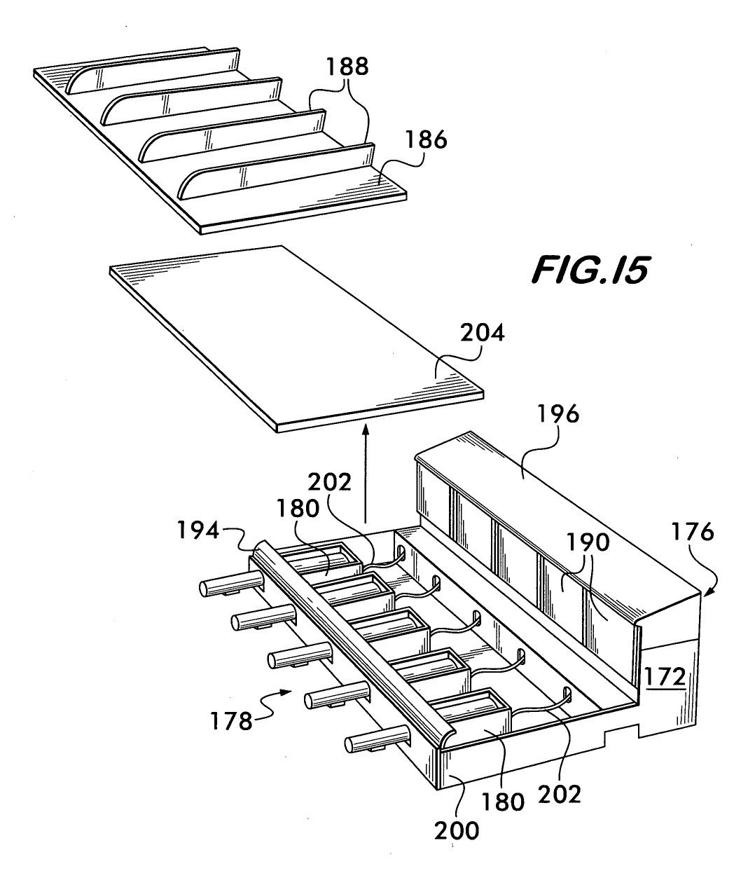

Referring to FIGS. 13 and 14, a display dispensing system 170 is shown for another embodiment of the present invention. The display dispensing system 170 enables consumers to view products displayed thereon and obtain samples of the products for testing prior to purchase. It is noted that the display dispensing system 170 is used to display and sample products which may be in the form of a flowable material, including, but not limited to, liquids, gels, foams, creams, slurries, pastes, powders, suspensions, aerosols, and the like. The display dispensing system 170 may be configured for placement on an existing counter of shelf, or mounting on a vertical structure such as a wall. In the present embodiment, the system 170 includes one or more display modules 172 each configured for placement in a juxtaposed side-by-side arrangement. Each of the display modules 172 are bounded at each end by shelf brackets 184 for facilitating coupling to top slotted wall standards (not shown) on a vertical fixture.

Each display module 172 includes, a dispensing assembly 178 with a plurality of fluid delivery mechanisms 180 disposed on the face portion thereof, a base member 186 having a top surface defining a product area 174 for holding products, and a rear compartment for storing sample dispenser bottles 176 (see FIG. 14). The display module 172 may further include a catch basin tray 182 disposed below the fluid delivery mechanisms 180. It is noted that the fluid delivery mechanism 180 is similar to the fluid delivery mechanism 104 described above.

The base member 186 includes a plurality of dividers 188 for partitioning the product area 174 into individual lanes 192 to maintain the products in a front-to-back layout. In a preferred embodiment of the present invention, the base member 186 and dividers 188 are composed of a light transmissible material such as an acrylic and operatively associated with a light source to enhance visibility of the product supported thereon as will be further described hereinafter The display module 174 further includes a plurality of panels 190 disposed along the rear portion of the base member 186, and a curvilinear front panel 194 disposed along the front portion of the base member 186. The panels 190 and 194 are configured to carry and convey graphical indicia in association with the product displayed. The panels 190 and 194 may further be composed of a light transmissible material to enhance visibility of the products and the graphical indicia supported thereon as will be further described hereinafter.

The fluid delivery mechanisms 180 of the dispensing assembly 178 are arranged in a side-by-side layout along the front side of the display module 172. Each fluid delivery mechanism 180 is positioned below a particular product occupying a corresponding product lane 192. It would be understood by the consumer that a product can be tested or sampled by simply operating or activating the fluid delivery mechanism 180 located directly below the product of interest. As shown in FIG. 14, the rear compartment 176 is adapted to accommodate one or more sample dispenser bottles 198 which can be accessed through a hinged flap door 196. The sample dispenser bottles 198 are adapted to store and supply a product to the corresponding fluid delivery mechanisms 180. By accessing the rear compartment 176 through the hinged flap door 196, a vendor or retailer can readily replenish exhausted sample dispenser bottles 198 with fresh ones and tailor or customize the panels 190 containing the graphical indicia as needed.

Referring to FIG. 15, the fluid delivery mechanisms 180 are located within a bottom portion 200 of the display module 172. The fluid delivery mechanisms 180 are each fluidly connected to a corresponding sample dispenser bottle 198 via a fluid tubing 202. The sample dispenser bottle 198 and the fluid tubing 202 are outfitted with complementary coupling members to form a quick connect-type coupling assembly to enhance ease of engagement and disengagement therebetween. The sample dispenser bottles 198 are each sealed until time of use. When the coupling member of the fluid tubing 202 releasably engages the coupling member of the sample dispenser bottle 198, a fluid passageway forms therebetween to enable sample dispensing.

The display module 172 further includes a support panel 204 which encloses the fluid delivery mechanisms 180 within the bottom portion 200 thereof. The base member 186 and dividers 188 are securely retained to the top surface of the support panel 204. In a preferred embodiment of the present invention, the support panel 204 is a light-generating device composed of light emitting diodes. The light generated from the support panel 204 illuminates the light transmissible base member 186, dividers 188, rear panels 190 and front panel 194, which significantly enhances the appearance of the product area 174 of the display module 172.

The foregoing discussion discloses and describes merely exemplar/embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A sample dispensing display system, comprising:
a dispensing assembly having top and front portions, and defining an interior cavity, said top portion of the dispensing assembly defining a product area for holding and displaying products;
at least one fluid delivery mechanism being disposed within the interior cavity of the dispensing assembly, said at least one fluid delivery mechanism each having a tubular shaft extending from the front portion of said dispensing assembly with an outlet disposed at the distal end of the tubular shaft; and
at least one sample dispenser source for storing a flowable material corresponding to a product displayed in the product area, said sample dispenser source being fluidly connected to a respective fluid delivery mechanism for supplying the flowable material.

2. The sample dispensing display system of claim 1 wherein the top portion of the dispensing assembly further comprises a plurality of dividers disposed thereon, said dividers being arranged in a spaced apart manner for segregating the product area into multiple lanes.

3. The sample dispensing display system of claim 1 wherein the top portion of the dispensing assembly further comprises a panel having a light source.

4. The sample dispensing display system of claim 3 wherein the top portion of the dispensing assembly further comprises a base member overlaying the light source panel, said base member being composed of a light transmissible material.

5. The sample dispensing display system of claim 1 further comprising a catch basin tray disposed below the tubular shaft of said fluid delivery mechanism.

6. The sample dispensing display system of claim 1 wherein said dispensing assembly further comprises:
a storage portion extending upwardly from the rear side thereof, said rear portion defining a compartment having an opening for receiving and retaining therein said at least one sample dispenser source; and
a hinged flap door attached to the storage portion for opening and closing access to the compartment.

7. The sample dispensing display system of claim 6 wherein the hinged flap door is located on top of the storage portion.

8. The sample dispensing display system of claim 1 wherein the storage portion comprises:
a front face extending along the top portion of the dispensing assembly; and
at least one panel reversibly mounted in a side-by-side arrangement on the front face of the storage portion, said panel each being configured for displaying graphical indicia.

9. The sample dispensing display system of claim 1 wherein the fluid delivery mechanism comprises:
sensing means for sensing an object positioned at a predetermined location from the outlet and subsequently generating a dispensing signal; and
delivery means responsive to the dispensing signal for delivering from a corresponding sample dispenser source a metered quantity of the flowable material through the outlet.

10. The sample dispensing display system of claim 9 wherein the delivery means of the fluid delivery mechanism comprises:
a solenoid; and
a nozzle assembly operatively associated with the solenoid.

11. The sample dispensing display system of claim 10 wherein the nozzle assembly comprises a head having an aperture through which the flowable material is dispensed in a metered quantity, said head including means for fixing the position of the aperture.

12. The sample dispensing display system of claim 9 wherein the sensing means of the sample dispenser comprises a remote sensor located at the distal end of the tubular shaft of the fluid delivery mechanism.

13. The sample dispensing display system of claim 12 wherein the remote sensor is an optical sensor.

14. The sample dispensing display system of claim 13 wherein the optical sensor comprises:
an optical transmitter;
an optical receiver; and
a sensor circuit board electrically connected to the optical transmitter and receiver.

15. The sample dispensing display system 1 further comprises mounting means for mounting the dispensing assembly to a support structure.

16. The sample dispensing display system of claim 1 further comprising a display housing enclosing the product area of the dispensing assembly.

17. The sample dispensing display system of claim 16 wherein the top portion of the dispensing assembly comprises:
a carrier located within the housing, said carrier being movable between retracted and extended positions relative to the housing;
said carrier having a top surface for supporting a product for display; and
said housing being further configured to secure the product with the carrier in the retracted position.

18. The sample dispensing display system of claim 17 wherein the top surface of the carrier comprises:
a first area for receiving and holding an inventory supply of products; and
a second area for receiving and displaying a representative of the inventory supply through the housing.

19. The sample dispensing display system of claim 18 wherein the first area includes at least one pusher mechanism configured for biasing the inventory supply of products toward a distal end of the carrier.

20. The sample dispensing display system of claim 16 wherein at least one portion of the housing is at least substantially non-opaque.
